(19) United States
(12) Patent Application Publication
(10) Pub. No.: US 2024/0370189 A1
(43) Pub. Date: Nov. 7, 2024

(54) Method And System For Writeable Persistent Storage For Container Based Applications Unaware of Orchestration System

(71) Applicant: Dell Products L.P., Round Rock, TX (US)

(72) Inventors: Trevor H. Dawe, Riverview (CA); Pooja Prasannakumar, Bangalore (IN); Thomas L. Watson, Richardson, TX (US)

(73) Assignee: Dell Products L.P., Round Rock, TX (US)

(21) Appl. No.: 18/142,256

(22) Filed: May 2, 2023

(51) Int. Cl. G06F 3/06; G06F 21/62

(52) U.S. Cl. CPC G06F 3/0632; G06F 3/062; G06F 3/065; G06F 3/067; G06F 21/6245

(57) ABSTRACT

Described herein are systems and methods for providing persistent storage for a container based application running on and unaware of a container orchestration system. An empty directory volume is mounted in a pod of the container orchestration system. A read to a persistent storage is performed by an init container of the pod. The persistent storage is not local to the node of the pod. Writing of the read is performed to the empty directory volume. The empty directory volume is to an application container that runs the container based application, allowing read/write operations between the empty directory volume and application container. Monitoring and providing changes is of the empty directory volume is performed to the persistent storage.

### BACKGROUND OF THE INVENTION

### Field of the Invention

The present invention relates to container-based applications running on information handling systems. More specifically, embodiments of the invention provide for providing writeable persistent storage of container based applications running on, and unaware of a container orchestration system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An emerging technology is container orchestration systems employing container platforms, such as Kubernetes. Container orchestration systems provide containers, where a container is a standard package of software, bundling application code along with configuration files and libraries. The use of container based applications allows the ability to deploy applications seamlessly across various environments (e.g., information handling systems).

A container orchestration system includes several hardware and software components that work together to manage deployment and execution of container-based applications. A cluster is a group of nodes and pods. A node is the smallest unit of compute hardware in a cluster. A pod is the smallest execution unit in a cluster. Pods run on particular nodes. Containers/container based applications are grouped in pods. Pods can be ephemeral, meaning that pods can exist and go away.

In certain instances, a container based application, such as one provided by a third party, is run on a particular container orchestration system, such as Kubernetes. The container based application is unaware that it is running on the particular container orchestration system (e.g., Kubernetes). An unaware container based application can be started/initiated on a pod and may need to write metadata to a persistent memory/storage. The unaware container based application may need to be able to retrieve and modify the metadata from the persistent storage.

Considering the ephemeral nature of pods and container-based applications, the unaware container based application needs access to the persistent memory/storage to provide metadata for other pods/resources on the container orchestration system. Since the container based application is unaware, it is not able to write to a persistent memory on the container orchestration system.

### SUMMARY OF THE INVENTION

A computer-implementable method, system and computer-readable storage medium for providing persistent storage for a container based application running on and unaware of a container orchestration system comprising mounting an empty directory volume in a pod of the container orchestration system; performing a read to a persistent storage by an init container of the pod, wherein the persistent storage is not local to a node of the pod; writing from the init container the read from the persistent storage to the empty directory volume; mounting the empty directory volume to an application container that runs the container based application, to allow read/write operations between the empty directory volume and application container; monitoring changes to the empty directory volume by a manager container; and providing by the manager container the changes to the persistent storage

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a diagram of interaction between components of in container orchestration system as implemented in the present invention; and

FIG. 3 is a generalized flowchart for providing writeable persistent storage of container based applications running on, and unaware of a container orchestration system.

### DETAILED DESCRIPTION

Described herein are systems and methods to provide persistent storage (i.e., memory) to a container based application that is running on a particular container orchestration system, such as Kubernetes. The container based application is unaware that it is running on the particular container orchestration system (e.g., Kubernetes). Implementations provide the use of available persistent volumes that provide storage that is not local to the node of the container based application. This allows container based application to share state between multiple replicas of the container based application. The state is accessible, even when the container based application is restarted on another node of the cluster.

Such persistent storage that is non-local to the node is not always available to the container based application. For implementations where Kubernetes is the container orchestration system, a Kubernetes secret can be used. A Kubernetes secret is a Kubernetes object that can be used to store small amounts of sensitive data. A Kubernetes secret can be encrypted, reducing exposing of sensitive data.

The Kubernetes container orchestration system implements a “etcd” database which is a consistent and available key value store typically used as a backing store for cluster data Kubernetes secrets can be persisted in the “etcd” database and accessed by multiple replicas of the container based application. The Kubernetes secret in the “etcd” database can also be accessed, if the container based application is restarted on another node. Therefore, the use of Kubernetes secret in this manner, can provide for saving small amounts of sensitive data, especially in situations where non-local persistent storage is not available. Examples of sensitive data can include passwords, certificates, etc. that are provided by the container based application.

Because Kubernetes secrets is a unique Kubernetes concept, container based applications, such as cloud-native applications written to run on multiple container orchestration systems, may not be able to make use of the specific capabilities provided by Kubernetes, such as Kubernetes secrets. For container based applications that are unaware that they are executing in a Kubernetes container orchestration system, one way to use a Kubernetes secret is mounting the Kubernetes secret as a volume, which allows the values in the Kubernetes secret to be available as a file inside a file system of the pod's containers. Such Kubernetes secret mounts are read only. If there are multiple replicas of the container based application mounting the same Kubernetes secret, modifications would not be available to other instances of the container based application. If the container based application is restarted, modifications made to the data in the Kubernetes secret would be lost. Implementations described herein make use of side car containers that work with the container based application, the Kubernetes secret, and an empty directory volume to provide persistent storage for the container based application

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

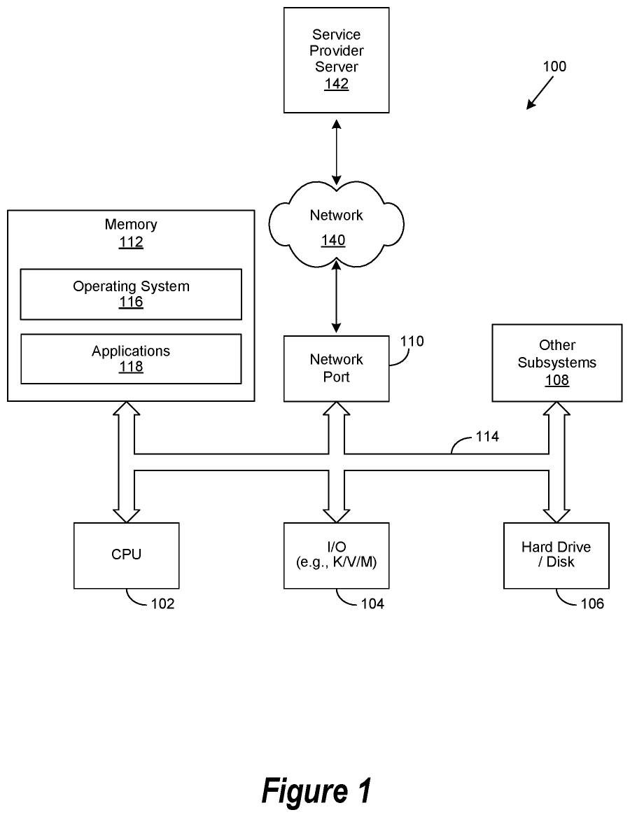

FIG. 1 is a generalized illustration of an information handling system (IHS) 100 that can be used to implement the system and method of the present invention. In particular, implementations provide for container orchestration systems and their components (e.g., container based applications), such as Kubernetes, to run on IHS 100.

The information handling system (IHS) 100 includes a processor (e.g., central processor unit or “CPU”) 102, input/output (I/O) devices 104, such as a microphone, a keyboard, a video display or display device, a mouse, and associated controllers (e.g., K/V/M), a hard drive or disk storage 106, and various other subsystems 108.

In various embodiments, the information handling system (IHS) 100 also includes network port 110 operable to connect to a network 140, where network 140 can include one or more wired and wireless networks, including the Internet. Network 140 is likewise accessible by a service provider server 142.

The information handling system (IHS) 100 likewise includes system memory 112, which is interconnected to the foregoing via one or more buses 114. System memory 112 can be implemented as hardware, firmware, software, or a combination of such. System memory 112 further includes an operating system (OS) 116, and one or more application(s) 118.

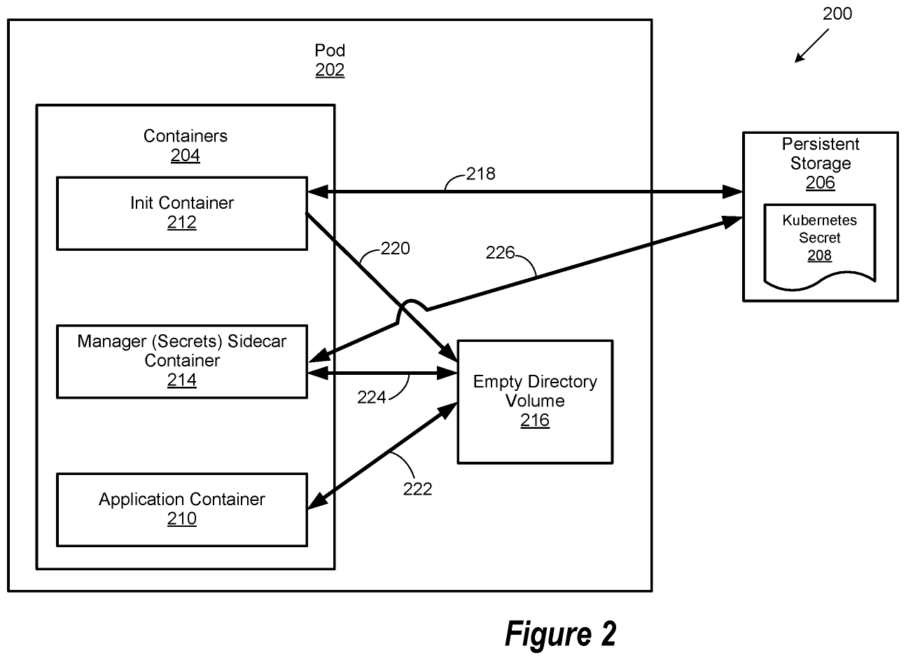

FIG. 2 illustrates a diagram of interaction between components of a container orchestration system. Implementations provide for a Kubernetes container orchestration system. Diagram 200 shows a portion of the container orchestration system. The container orchestration system includes multiple pods, including a pod 202. Multiple pods make up a cluster in the container orchestration system. Pods run on particular nodes of the container orchestration system. The pod 202 includes containers 204.

The container orchestration system can include persistent storage that is not local to a node, such as persistent storage 206. In certain implementations, when a Kubernetes container orchestration system is used, the persistent storage 206 can store a Kubernetes secret 208. The Kubernetes secret 208 is created to include sensitive data that container based applications and their replicas need access to.

Persistent storage 206 can be a “etcd” database of a Kubernetes container orchestration system. Other implementations provide that persistent storage 206 to be a service such as “hashicorp vault,” and config map, object store, etc. Persistent storage 206 being an object that provides persistent storage accessible by other clusters/container based applications running on the container orchestration system.

Containers 204 include a container based application or application container 210. The application container 210 runs a container based application that may be provided by a third party. The container based application is unaware that it is running on the particular container orchestration system (e.g., Kubernetes). Containers 204 further include an init container 212 and a manager side car container 214. The init container 212 and a manager side car container 214 are aware of the particular container orchestration system (e.g., Kubernetes aware). The manager side car container 214 can be specifically used for Kubernetes secret 208. Init container 212 and manager side car container 214 are separate containers that are run alongside the application container 210.

Implementations further provide for an empty directory volume 216 to be included/local to the pod 202. In particular, the pod 202 is configured to mount the empty directory volume 216. The empty directory volume 216 is an ephemeral volume that lasts only for the lifetime of the pod 202. The empty directory volume 216 . . . is used as storage local to the node that application container 210 runs on.

During operation, at 218, the init container 212 reads from the persistent storage 206, such as data of Kubernetes secret 208. The init container 212 is configured to begin/operate when the pod 204 is initiated. At 220, the init container 212 writes the volume (e.g., the contents of Kubernetes secret 208) that is read from the persistent storage 206, to the empty directory volume 216. After the write operation of 220, the init container 212 is no longer needed.

At 222, application container 210 which runs the application logic of the container based application, mounts the empty directory volume 216. Read/write operations are performed between the application container 210 and empty directory volume 216, as if the empty directory volume 216 were a persistent volume.

At 224, manager side car container 214 monitors changes to the empty directory volume 216, such as changes made by the application container 212. At 226, the manager side car container 214 updates the directory volume 216 and in certain cases updates the Kubernetes secret 208. The changes (e.g., Kubernetes secret 208) are made available to other replicas of the container based application. Examples of changes/updates provided by application container include passwords, certificates, etc.

The init container 212 and manager side car container 214 are aware of the particular container orchestration system (e.g., Kubernetes aware) and are configured to keep data in empty directory volume 216 that is mounted to application container 210 in sync with data in the persistent storage 206/Kubernetes secret 208, allowing container based application unaware of the particular container orchestration system (e.g., Kubernetes) to use the persistent storage 206/Kubernetes secret 208 as writeable persistent storage. Therefore, the container based application is able to share application state and modifications with other replicas of the container based application on other nodes having a need for persistent storage that is non local to the node. This is particularly useful when non-local persistent storage is not available.

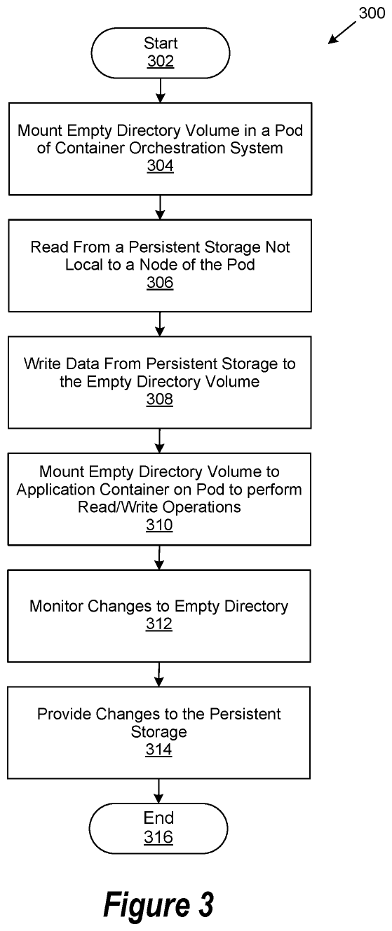

FIG. 3 shows a generalized flowchart for writeable persistent storage of container based applications running on, and unaware of a container orchestration system. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 302, the process 300 starts. At step 304, the pod 202 mounts the empty directory volume 216. Pod 202 being part of a particular container orchestration system. At step 306, through the init container 212, a read is performed on persistent storage 206. Persistent storage 206 is not local to the node of the pod 202. At step 308, from the init container 212 data read from persistent storage 206 is written to empty directory volume 216. At step 310, the empty directory volume 216 is mounted to application container 210 to allow read/write operations between the empty directory volume 216 and the application container 210. At step 312, changes to the empty directory volume 216 are monitored by manager sidecar container 214. At step 314, the manager sidecar container 214 provides changes to the persistent storage 206. At step 316, the process 300 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for providing persistent storage for a container based application running on and unaware of a container orchestration system comprising:
mounting an empty directory volume in a pod of the container orchestration system;
performing a read to a persistent storage by an init container of the pod, wherein the persistent storage is not local to a node of the pod;
writing from the init container data read from the persistent storage to the empty directory volume;
mounting the empty directory volume to an application container that runs the container based application, to allow read/write operations between the empty directory volume and application container;
monitoring changes to the empty directory volume by a manager container; and
providing by the manager container the changes to the persistent storage.

2. The computer-implementable method of claim 1, wherein the container orchestration system is Kubernetes.

3. The computer-implementable method of claim 1, wherein the persistent storage includes a Kubernetes secret.

4. The computer-implementable method of claim 1, wherein the init container and the manager container are aware of the container orchestration system.

5. The computer-implementable method of claim 1, wherein the persistent storage is one of a secret, config map, or object store.

6. The computer-implementable method of claim 1, wherein data of the persistent storage is available to replicas of the container based applications.

7. The computer-implementable method of claim 1, wherein data in the persistent storage is sensitive information.

8. A system comprising:
a plurality of processing systems communicably coupled through a network, wherein the processing systems include non-transitory, computer-readable storage medium embodying computer program code interacting with a plurality of computer operations providing persistent storage for a container based application running on and unaware of a container orchestration system comprising:
mounting an empty directory volume in a pod of the container orchestration system;
performing a read to a persistent storage by an init container of the pod, wherein the persistent storage is not local to a node of the pod;
writing from the init container data read from the persistent storage to the empty directory volume;
mounting the empty directory volume to an application container that runs the container based application, to allow read/write operations between the empty directory volume and application container;
monitoring changes to the empty directory volume by a manager sidecar container; and
providing by the manager sidecar container the changes to the persistent storage.

9. The system of claim 8, wherein the container orchestration system is Kubernetes.

10. The system of claim 8, wherein the persistent storage includes a Kubernetes secret.

11. The system of claim 8, wherein the init container and the manager container are aware of the container orchestration system.

12. The system of claim 8, wherein the persistent storage is one of a secret, config map, or object store.

13. The system of claim 8, wherein data of the persistent storage is available to replicas of the container based applications.

14. The system of claim 8, wherein data in the persistent storage is sensitive information.

15. A non-transitory, computer-readable storage medium embodying computer program code for providing persistent storage for a container based application running on and unaware of a container orchestration system, the computer program code comprising computer executable instructions configured for:
mounting an empty directory volume in a pod of the container orchestration system;
performing a read to a persistent storage by an init container of the pod, wherein the persistent storage is not local to a node of the pod;
writing from the init container data read from the persistent storage to the empty directory volume;
mounting the empty directory volume to an application container that runs the container based application, to allow read/write operations between the empty directory volume and application container;
monitoring changes to the empty directory volume by a manager container; and
providing by the manager container the changes to the persistent storage.

16. The non-transitory, computer-readable storage medium of claim 15, wherein the container orchestration system is Kubernetes.

17. The non-transitory, computer-readable storage medium of claim 15, wherein the persistent storage includes a Kubernetes secret.

18. The non-transitory, computer-readable storage medium of claim 15, wherein the init container and the manager container are aware of the container orchestration system.

19. The non-transitory, computer-readable storage medium of claim 15, wherein the persistent storage is one of a secret, config map, or object store.

20. The non-transitory, computer-readable storage medium of claim 15, wherein data of the persistent storage is available to replicas of the container based applications.
